(19) United States
(12) Patent Application Publication
(10) Pub. No.: US 2003/0132397 A1
(43) Pub. Date: Jul. 17, 2003

(54) Method of and apparatus for ensuring proper orientation of an object for ion implantion

(76) Inventor: Seung-Man Nam, Kyunggi-do (KR)

Correspondence Address: VOLENTINE FRANCOS, P.L.L.C., Suite 150, 12200 Sunrise Valley Drive, Reston, VA, 20191, US

(21) Appl. No.: 10/197,485

(22) Filed: Jul. 18, 2002

(30) Foreign Application Priority Data
Jan. 15, 2002 (KR) 2002-2298

(51) Int. Cl. G01J 1/00; G01N 21/00

(52) U.S. Cl. 250/491.1

(57) ABSTRACT

An object alignment inspecting apparatus is used to prevent a channeling phenomenon form occurring in an ion implantation process. The apparatus includes a body having the shape of an object to be processed and a series of graduations extending along its outer peripheral edge, a center post protruding from the center of the body; and an indicator having a rotary member freely rotatably mounted to the post and extending from the post to the graduations. In use, the alignment angle inspecting apparatus is placed on the disc of ion implantation equipment that is used to support the object during the ion implantation process. The relative rotational position of the apparatus on the disc is read. This information is used to determine whether the object, when placed on the disc, will assume a relative rotational position which will not give rise to the channeling phenomenon. Also, the object alignment inspecting apparatus may have a plumb mechanism and graduations so that the slope of the disc can be determined as well. The slope of the disc can be adjusted based on the reading taken form the plumb mechanism so as to also ensure that the channeling phenomenon will not occur.

### BACKGROUND OF THE INVENTION

1. Field of the Invention

The present invention relates to ion implantation equipment. More particularly, the present invention relates to the orienting of an object, such as a wafer, for ion implantation such that ions will be implanted into the object to a desired depth.

2. Brief Description of the Related Art

In general, ion implantation equipment is used to extract ions, accelerate the ions at a high voltage, and inject the accelerated ions to a predetermined depth in an object positioned in the path of the ions. To facilitate the ion implantation process, the ion implantation equipment directs the ion beam onto the surface of the object as well as scans the surface of the object with the ion beam. However, the object must be inclined at a predetermined angle relative to the incoming direction of the ion beam to prevent the ions from being implanted to a depth greater than the desired depth. More specifically, inclining the object increases the possibility that the implanted ions will collide with atomic nuclei of the crystal lattice structure of the object, namely a wafer, whereby the depth to which the ions penetrate the object is restricted by the crystal lattice structure.

To prevent the ions from penetrating too deeply into the wafer, the wafer (W) must, however, be oriented within an extremely limited range. A channeling phenomenon occurs if the orientation of the wafer is outside a predetermined narrow range whereupon the ions infiltrate the wafer beyond the desired depth. The channeling phenomenon manifests itself as an undesired change in the property of lower layers or an electrically conductive connection of the layers. In other words, the wafer must be oriented accurately relative to the direction of the incoming ion beam (hereinafter referred to as the “implanting direction”) to prevent the channeling phenomenon from occurring. The orientation of the wafer (W) is determined by a combination of the slope (θ) of the wafer as shown in FIG. 1, and a relative rotational position (θ′) of the crystal lattice structure of the wafer, as shown in FIG. 2. The effect of the slope (θ) and relative rotational position (θ′) of the wafer on the results of the ion implantation process will now be described in more detail with reference to FIGS. 1-5.

The slope (θ) of the wafer is the angle subtended by the plane of the wafer and the ion beam implanting direction (I), whereas the relative rotational position (θ′) of the wafer is the angle subtended by the direction of the crystal lattice structure and the scanning direction (S) of the ion beam. The wafer W is oriented such that the aforementioned slope (θ) and relative rotational position (θ′) of the wafer (W) increase the probability that the implanted ions will collide with the atomic nuclei of the crystal lattice structure. Note, in this case, the silicon crystals of the wafer form a face-centered cubic lattice, as shown in FIG. 3.

If the slope (′) of the wafer (W) were 90° and the relative rotational position (θ′) of the wafer were 0°, the atomic nuclei of the crystal lattice structure of the silicon wafer (W) would exhibit a wide spacing with respect to the ion implanting and scanning directions, as shown in FIG. 4a. In this case, a high percentage of the ions can pass into the wafer (W) without impinging atomic nuclei of the crystal lattice structure, thereby causing the aforementioned channeling phenomenon to occur.

On the other hand, if the slope (θ) of the wafer were 45° and the rotational angle (θ′) of the wafer were 7°, the aligned atomic nuclei would exhibit a narrower spacing than the case shown in FIG. 4a. Nonetheless, as shown in FIG. 4b, a high percentage of the implanted ions can still pass freely by the atomic nuclei, whereby the channeling phenomenon may occur.

Furthermore, if the slope (θ) of the wafer were 35° and the relative rotational position (θ′) of the wafer were 8°, the aligned atomic nuclei would exhibit even a narrower spacing, as shown in FIG. 4c. However, even this orientation of the wafer (W) results more or less in a channeling phenomenon, i.e., is not capable of achieving the desired results of the ion implantation process.

To the contrary, when the slope (θ) of the wafer is about 68°±1 and the relative rotational position (θ′) of the wafer is 7±0.5°, the atomic nuclei exhibit a dense arrangement against which most of the implanted ions will collide, as shown in FIG. 4d. Thus, the depth to which the ions can penetrate the wafer (W) is restricted by this orientation of the wafer (W), i.e., the orientation of the crystal lattice structure of the silicon. Accordingly, such an orientation of the wafer is ideal for the ion implantation process.

The conventional ion implantation equipment for orienting the wafer (W), i.e., for establishing the slope (θ) and relative rotational position (θ′) of the wafer (W), will now be described with respect to FIG. 5. As shown in FIG. 5, a wafer (W) ejected from a load lock (L/L) chamber by a robot (R) is first positioned at an alignment unit (A). There, the wafer (W) is oriented (aligned) at a predetermined relative rotational position (θ′). The robot (R) transfers the aligned wafer (W) from the alignment unit (A) to a disc (D) of a turntable (T) that supports the wafer (W) at a predetermined slope (θ) and in a relative rotational position (θ′).

However, it is impossible to confirm whether the alignment unit (A) has accurately aligned the wafer (W) In other words, it is impossible to confirm whether the wafer (W) has been oriented by the alignment unit (A) to a relative rotational position (θ′) within a predetermined range.

In addition, there is another problem in that it is impossible to confirm whether the wafer (W) mounted on the disk (D) is oriented at a desired slope (θ) with respect to the ion beam implanting direction (I).

As described above, if the values of the slope (θ) and relative rotational position (θ′) of the wafer are outside predetermined ranges, processing defects due to the channeling phenomenon may occur. In this case, the production yield of the semiconductor devices is reduced, and the manufacturing cost of the semiconductor devices is correspondingly increased.

### SUMMARY OF THE INVENTION

It is an object of the present invention to solve the aforementioned problems of the prior art. More specifically, it is an object of the present invention to reduce processing defects in the ion implantation process by, for example, preventing the chaneling phenomenon from occurring.

To achieve these objects, the present invention provides a method of and an apparatus for confirming whether the inclination and/or relative rotational position of an object, when readied for ion implantation, will fall within a predetermined range whereby ions will be implanted into the object no further than to a desired depth.

An object alignment angle inspecting apparatus according to the present invention comprises a body having the shape of an object, e.g. a wafer, to be processed in the ion implantation equipment, and a series of graduations spaced from one another along a circle so as to represent angles corresponding to relative rotational positions that the apparatus may assume, a center post protruding from the body at the center of the circle, and an indicator for marking a graduation indicative of the relative angular position of the apparatus.

The indicator includes a rotary member mounted to the post so as to be free to rotate about the body, and extends from the post to the graduations.

The rotary member may have an annular member extending freely around the center post, a connecting member having a first end fixed to the annular member and a second end disposed adjacent the graduations, and a weight connected to the second end of the connecting member.

Alternatively, the rotary member may comprises a main plate facing the body and mounted to the post so as to rotate freely about the central axis of the center post parallel to the body. The main plate has an indicator mark adjacent the graduations to mark the graduation indicating the relative rotational position of the apparatus. The main plate preferably is also provided with auxiliary graduations extending alongside the main graduations. The auxiliary graduations are spaced from one another by intervals that are different form the intervals by which the main graduations are spaced for increasing the accuracy of the angle indicated by the apparatus.

In addition, the indicator may have means by which the slope or inclination of the apparatus can be read. To this end, an indicator of the apparatus includes at least one auxiliary plate extending upright from a rotary member, and an indicating member mounted to the rotary member so as to swing freely relative thereto. The auxiliary plate has graduations spaced along an arc lying in a plane perpendicular to the rotary member. The indicating member extends to the arc, i.e., to the graduations, whereby the graduation of the auxiliary plate indicated by the indicating member is indicative of the angle at which the body is inclined relative to the vertical. The indicating member may comprise a string and a weight, or a plate having an indicating mark.

In use, the alignment angle inspecting apparatus is placed on the disc of the ion implantation equipment. Once this happens, the relative rotational position of the apparatus on the disc can be read off of the graduations using the indicator. Subsequently, the transportation device of the ion implantation equipment, e.g. the robot, is used to transfer the object alignment angle inspecting apparatus from the disc to the alignment unit of the ion implantation equipment. Once this happens, the relative rotational position of the apparatus in the alignment unit is noted using the graduations of the apparatus. To this end, the alignment unit may be provided with a guide, a slider slidable along the guide, and an indicating pin protruding from the slider to indicate a graduation of the alignment angle inspecting apparatus disposed in the alignment unit. Finally, the relative rotational positions of the object alignment angle inspecting apparatus on the disc and in the alignment unit are compared to determine whether the object transported by the transportation unit from the alignment unit to the disc will assume a rotational position on the disc within a predetermined range relative the direction of scan of the ion beam.

When the determination reveals that the relative rotational position of the object will be outside the predetermined range, the position of the disc is adjusted appropriately to pre-empt such a misalignment of the object.

Moreover, the object alignment angle inspecting process repeated, including in reverse, to make sure that the alignment unit and transportation device are providing/maintaining the proper alignment of the object up to the time the object is disposed on the disc.

### BRIEF DESCRIPTION OF THE DRAWINGS

These and other objects, features and advantages of the present invention will become clearer from the following detailed description of the preferred embodiments thereof made with reference to the accompanying drawings, of which:

FIG. 1 is a sectional view of a wafer, inclined relative to the ion implanting direction;

FIG. 2 is a plan view of the wafer showing its angular position relative to an ion-beam scanning direction;

FIG. 3 is a perspective view of a unit of the crystal lattice structure of a silicon wafer;

FIGS. 4a through 4d are schematic diagrams illustrating respective relationships between the crystal lattice structure and the rotational position of the wafer;

FIG. 5 is a schematic diagram of conventional ion implantation equipment showing a wafer loading apparatus for loading a wafer onto a disc where the ion implantation process takes place;

FIG. 6 is a perspective view of a first embodiment of an alignment angle detector in accordance with the present invention;

FIG. 7 is a perspective view of another embodiment of an object alignment angle detector in accordance with the present invention; and

FIG. 8 is another perspective view of the alignment angle detector of FIG. 7, illustrating the use of the detector in an inspecting method according to the present invention.

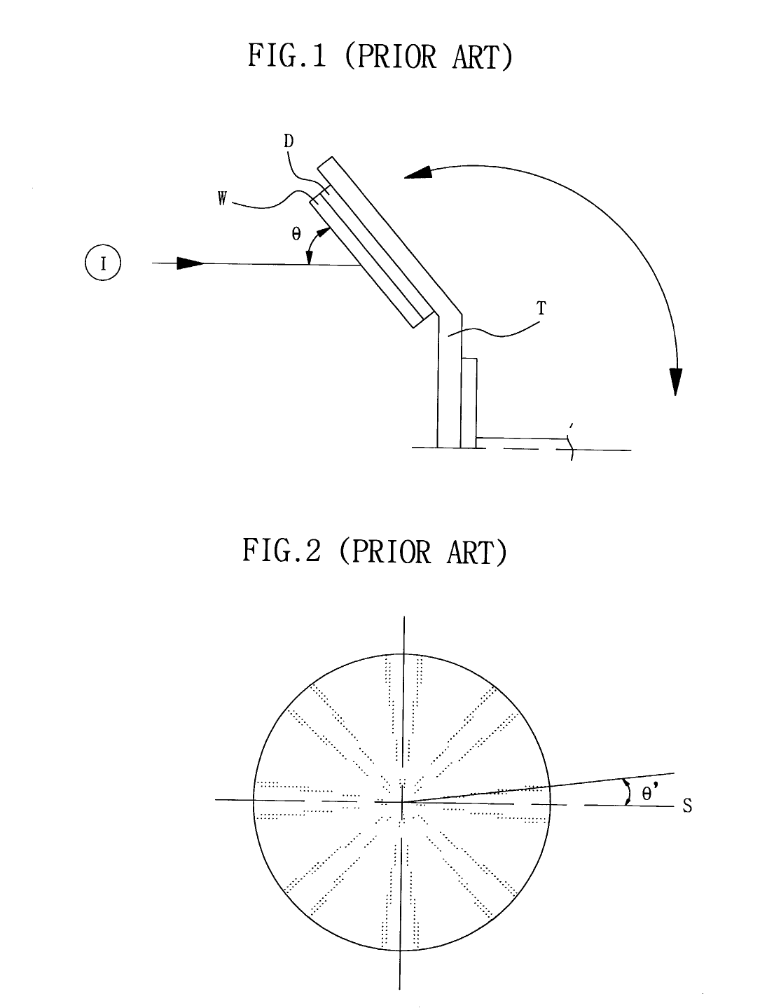

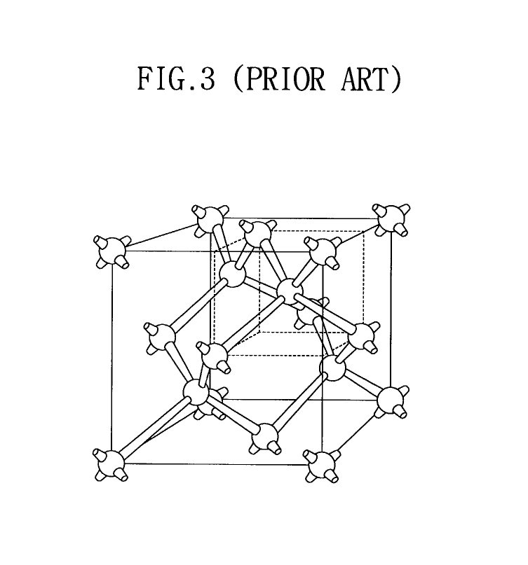

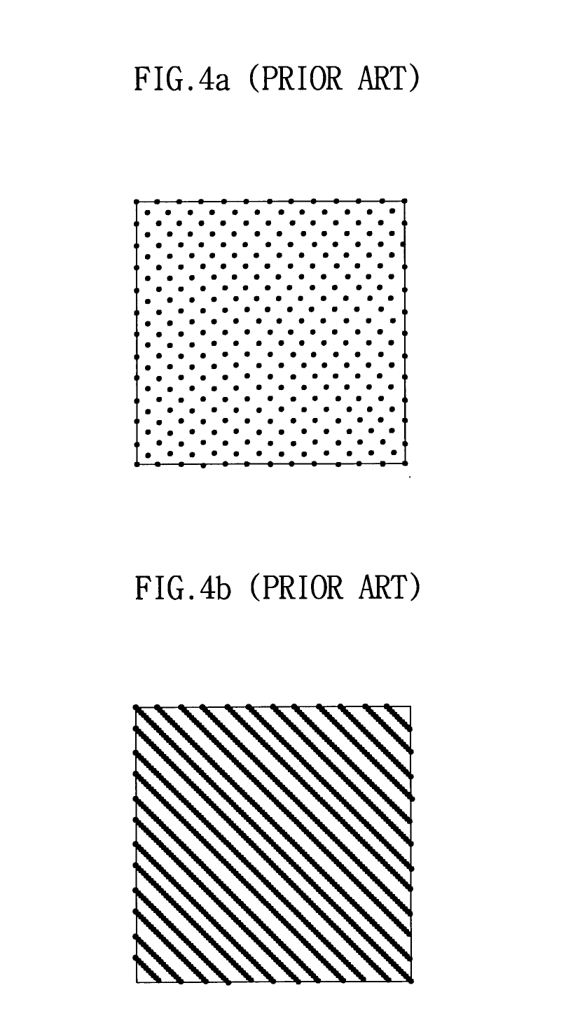

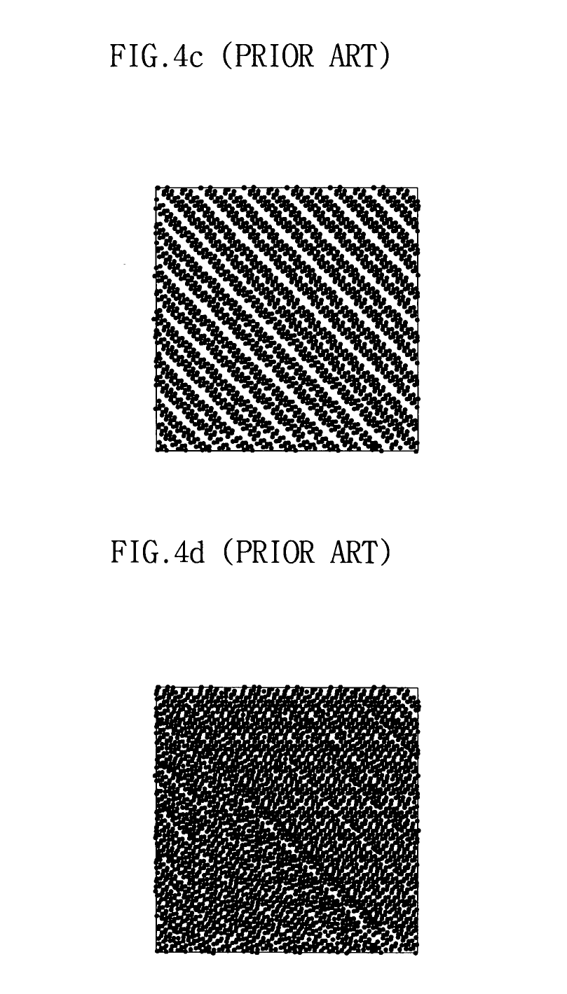

### DETAILED DESCRIPTION OF THE PREFERRED EMBODIMENTS

Hereinafter, an object alignment angle detector for use in ion implantation equipment and the method of inspecting an object using the same will be described with reference to accompanying drawings. Note, like reference numerals are used to designate like parts throughout the drawings.

Referring first to FIG. 6, In accordance with the present invention, an object alignment angle inspecting apparatus 10a comprises a generally planar body 12 having the same outer shape as a wafer (W) used for manufacturing semiconductor devices. The entire outer peripheral edge of the body 12 has graduations 16 indicating angles subtended relative to a reference line extending from the center of the body 12.

The apparatus 10a also comprises a center post 14 disposed at the center of the upper surface of the body 12 so as to be coaxial therewith, and an indicator 18a freely rotatably mounted to the center post 14 so as to be free to rotate about the central axis of the post 14, i.e. so as to act as a pendulum. More specifically, the indicator 18a includes: a rotary member 20 in the form of a ring extending freely around the center post 14, a connecting member 22 having a first end fixed to the outer edge of the rotary member 20 and a second end disposed close to the graduations 16 extending along the outer peripheral edge of the body 12, and a weight 24 connected at the second end of the connecting member.

The weight 24 is in the form of a pointer. The graduations 16 are spaced from one another along a circle whose center lies at the central axis of the center post 14. The indicator 18a marks a graduation 16 corresponding to the direction in which a load, i.e., the force of gravity, acts on the weight 24 from the central axis of the body 12. The graduation thus marked is indicative of the angle subtended between a reference line extending radially from the center of the circle and the indicator 18a, i.e., is indicative of the relative rotational position of the detector 10a.

The connecting member 22 basically comprises a string. The string is fixed to the rotary member 20 via a through-hole extending through a portion of the rotary member 20 radially from the central axis of the center post 14. One end of the string passes through the through-hole where it is secured to the inside of the rotary member 20 without any interference from the center post 14. The other end of the string is connected to the weight 24.

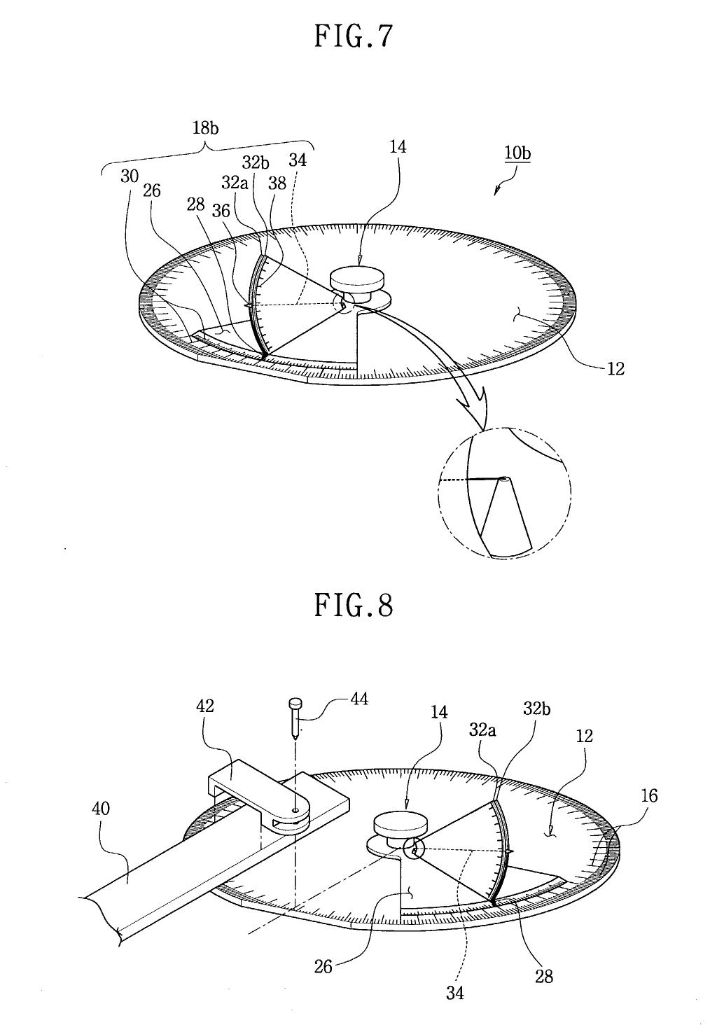

In the embodiment of the object alignment angle inspecting apparatus 10b shown in FIG. 7, the indicator 18b includes a rotary member 26 comprising a plate disposed close to the upper surface of the body 12. The plate has an overall shape corresponding to a segment of the body 12 as shown in the figure. The rotary member 26 also has an annular portion by which the member 26 is rotatably supported by the center post 14 so as to act as a pendulum. Furthermore, a mark 28 is formed at a predetermined position along the radially outermost edge of the plate of the rotary member 26 to indicate the graduation 16 that corresponds to the direction in which a load, i.e., the force of gravity, acts on the rotary member 26 from the central axis of the body 12. The mark 28 may take the form of a protrusion.

In addition, as shown in FIG. 7, the outer peripheral edge of the rotary member 26 is provided with auxiliary graduations 30 indicating angles subtended with respect to the central axis of the body 12. Preferably, the intervals between the auxiliary graduations 30 differ from, i.e., are larger or smaller than, those between the graduations 16.

That is, the graduations 16 of the body 12 and the auxiliary graduations 30 of the rotary member 26 have different intervals like a vernier caliper or micrometer. In other words, the graduations 16 of the body 12 serve as main scale graduations and the auxiliary graduations of the rotary member 26 serve as vernier graduations, so that it is possible to more accurately ascertain the angle indicated by the mark 28.

In addition, as shown in FIG. 7, the indicator 18b includes at least one auxiliary plate 32 disposed perpendicular to the plate of the rotary member 26 and lying in a plane extending from the location where the mark 28 is formed to the central axis of the body 12. In this respect, the auxiliary plate(s) 32 enhances the effect of indicating the direction in which the load acts on the rotary member 26, that is, the function of the mark 28. The case of two auxiliary plates 32a, 32b will be used in the following description.

The auxiliary plates 32a, 32b have arcuate peripheral edges that are juxtaposed relative to one another. Graduations 38 are provided along an arc adjacent the peripheral edges of the auxiliary plates 32a, 32b. The arc lies in a plane perpendicular to the body 12 and rotary member 26 and has a radius of curvature emanating from the central axis of the post 14.

The indicator 18b also includes a connecting string 34 extending between the plates 32a, 32b from a location adjacent the central axis of the post 14, and a weight 36 connected to the distal end of the connecting string 34. The weight 36 protrudes form between the plates adjacent the graduations 38 to indicate a slope (θ) subtended by the connecting string 34 and the upper surface of the body 12.

In addition, the fixed end of the connecting string 34 is preferably located a predetermined distance above the upper surface of the body 12, and the graduations 38 are a series of short lines each of which will extend parallel to the connecting string 38 when the weight is 36 is positioned in alignment therewith. Furthermore, the connecting string 38 and the auxiliary plates 32a, 32b may be fixed closer to the center axis 14 and positioned with a roller (not shown) to accurately form the angle that indicates the slope (θ).

As an alternative, the connecting string 34 may be replaced by a plate similar to that of the rotary body 26. In this case, the graduations 38 may be main scale graduations and the plate may be provided with an indicating mark and auxiliary graduations.

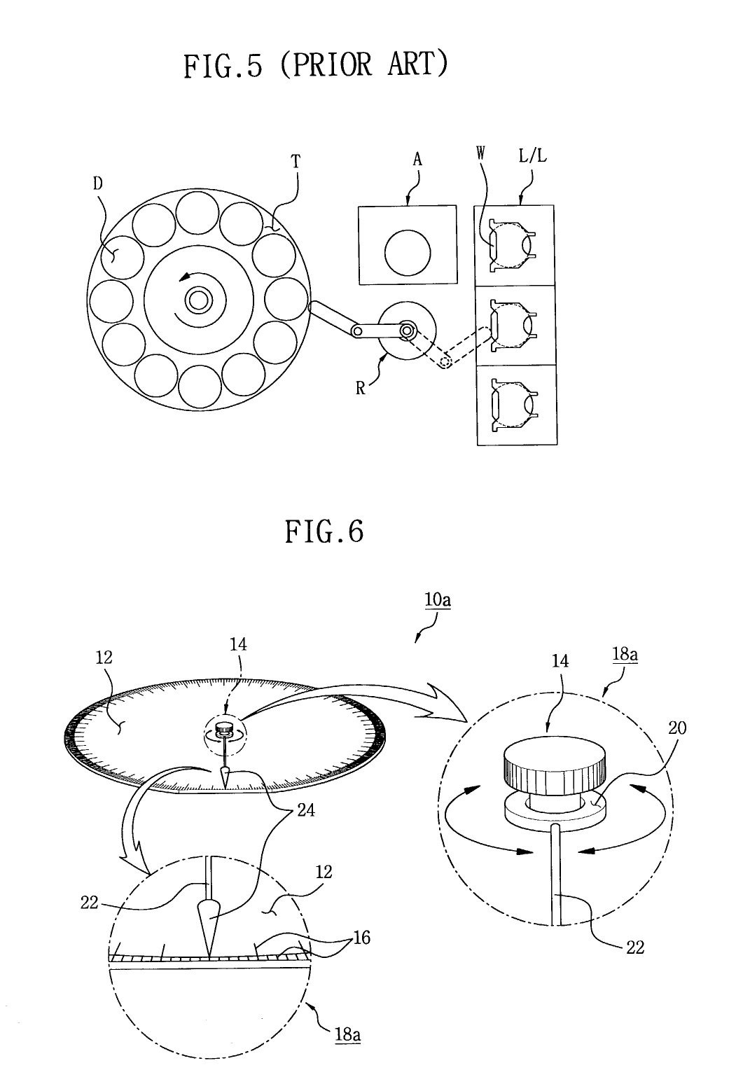

Next, a method of confirming the orientation of a wafer (or other object) using the object alignment angle inspecting apparatus 10a, 10b will be described with reference to FIGS. 5-8.

The object alignment angle inspecting apparatus 10a, 10b is placed in the ion implanting equipment atop the disc (D) that is positioned in the path along which an ion beam is directed. At this time, the indicator 18a, 18b rotates relative to the center post 14 under the force of gravity to indicate the graduation 16 designating the angle corresponding to the relative rotational position of the body 12. Hence, a graduation 16 representing a relative rotational position of the apparatus is indicated by the pendulum, more specifically, by the weight 24 of the embodiment of FIG. 6 or the mark 28 of the rotary member 26 of the embodiment of FIG. 7. Subsequently, the apparatus 10a, 10b is used to confirm the relative rotational position (θ′) of the wafer (W) on the disc (D) during the ion implantation process, for instance, where a flat zone of the wafer (W) or a mark that shows the orientation of the lattice structure of the wafer (W) will lie on the disc (D) after the wafer (W) has been transported to the disc (D).

First, the robot (R) is used to transport the alignment angle inspecting apparatus 10a, 10b from the disc (D) onto the alignment unit (A) before the wafer (W) is loaded onto the disc (D). The alignment angle inspecting apparatus 10a, 10b is placed in the alignment unit (A) at the same orientation that will be given to a wafer (W) by the alignment unit (A). Thus, the alignment angle inspecting apparatus (A) can be used to determine whether the wafer (W) will have a relative rotational position (θ′) falling within a predetermined range once the wafer (W) has been transported by the same robot (R) from the alignment unit (A) to the disc (D) by confirming that the graduation 16 indicated when the apparatus 10a, 10b was disposed on the disc (D) arrives at an appropriate location in the alignment unit (A).

To this end, the alignment unit (A) may be provided with an auxiliary device to confirm exactly where the alignment angle inspecting apparatus 10a, 10b is positioned relative to the aligner of the alignment unit (A). As shown in FIG. 8, the auxiliary device comprises a guide 40, a slider 42 received on the guide 40 so as to be slidable therealong, and an indicating pin 44 supported by the slider.

The guide 40 is fixed so as to extend parallel to the diametric direction of the alignment angle inspecting apparatus 10a, 10b when the alignment angle inspecting apparatus 10a, 10b is placed in the alignment unit (A). Opposite sides of the slider 42 protrude from the sides of the guide 40 so as to face the graduations 16. A through hole extends vertically through one of these protruding sides of the slider 42. The indicating pin 44 extends through the through hole to a position just above the graduations 16. Therefore, once the alignment angle inspecting apparatus 10a, 10b is transported by the robot (R) from the disc (D) into the alignment unit (A), the indicating pin 44 is used to check the relative rotational position (θ′) of the alignment angle inspecting apparatus 10a, 10b. A comparison between the graduation 16 indicated by the pendulum when the alignment angle inspecting apparatus 10a, 10b is disposed on the disc (D), and the graduation 16 indicated by the indicating pin 44 when the alignment angle inspecting apparatus 10a, 10b is disposed in the alignment unit (A), thus reveals whether a wafer (W) will be oriented the disc (D) in a desired relative rotational position (θ′).

If not, an adjustment is made to the ion implantation equipment, e.g., to the position of the disc (D), that ensures that the wafer (W) will be oriented in a relative rotational position (θ′) within a predetermined acceptable range.

Next, the alignment angle inspecting apparatus 10a, 10b may be transported between the load lock chamber (L/L) and the alignment unit (A) by the robot (R) to once again monitor whether there is any movement of the apparatus 10a, 10b from its relative rotational position (θ′). This action is then compared with the state of movement of the alignment angle inspecting apparatus 10a, 10b from the disc (D) to the alignment unit (A). Accordingly, the operation of the alignment unit (A) within normal parameters can be confirmed and, if necessary, the driving mechanism of the alignment unit (A) can be adjusted.

If the above-described steps are repeated in reverse, it is possible to check whether the wafers (W) will be misaligned by the transportation device (robot R). If so, the robot (R) of the ion implantation equipment is adjusted. Then, the robot (R) in this adjusted state is used to transport the wafers (W) to the alignment unit (A) and, from there, onto the disc (D). Accordingly, the wafers (W) will assume a proper relative rotational position (θ′) during the ion implantation process.

Furthermore, when the embodiment of FIG. 7 is disposed on the disc (D), the connecting string 34 acts as a plumb bob to make an angle with the upper surface of the body 12, as indicated by the weight 36 on the graduations 38 formed along the peripheral edges of the auxiliary plates 32a, 32b. This angle is indicative of the inclination of the alignment angle inspecting apparatus 10b relative to the ion beam implanting direction (I), that is, the slope (θ) of a wafer (W) disposed on the disc (D). Also, in this case, the auxiliary graduations 30 of the rotary member 26 and/or the auxiliary graduations provided on a rotary member (not shown) extending between the plates 32a, 32b may be used to more accurately determine the relative rotational position (θ′) and/or slope (θ) that the wafer (W) will assume on the disc (D). If the slope (θ) falls outside of a predetermined range, the position of the turntable (T) is adjusted.

According to the present invention as described above, the relative rotational position (θ′) and/or the slope (θ) of a wafer (W) on the disc (D) can be confirmed using the object alignment angle inspecting apparatus. If the use of the object alignment angle inspecting apparatus reveals that these angles will not fall within predetermined ranges, the ion implantation equipment is adjusted appropriately. Hence, the wafer (W) will be oriented such that a channeling phenomenon is prevented from occurring in connection with the ion implantation process. As a result, the processing efficiency, manufacturing yield, and productivity of the ion implantation process are improved.

Finally, although the present invention has been described above with respect to the preferred embodiments thereof, it will be understood that the invention is not limited to the preferred embodiments. Rather, various changes and modifications may be made to the preferred embodiments without departing from the true spirit and scope of the invention as defined in the appended claims.

What is claimed is:

1. An object alignment inspecting apparatus for use in ion implantation equipment, comprising:
a body having the outer shape of an object to be processed in the ion implantation equipment, and a series of graduations spaced from one another along a circle, each graduation thereby indicating the angle subtended between a reference line extending radially from the center of the circle and a line extending radially from the center of the circle across the graduation;
a center post protruding from said body and having a central axis coincident with the center of the circle; and
an indicator comprising a rotary member mounted to said post so as to be free to rotate about the central axis thereof, said rotary member extending from said post to said graduations, whereby said indicator has the form of a pendulum.

2. The apparatus as claimed in claim 1, wherein said rotary member includes an annular member extending freely around said center post, a connecting member having a first end fixed to said annular member and a second end disposed adjacent the circle along which the graduations of the body are spaced, and a weight connected to said second end of the connecting member.

3. The apparatus as claimed in claim 2, wherein said annular member has a radial through hole extending in a direction that intersects the central axis of the post, and the connecting member comprises a piece of string, the piece of string having one end extending through said through hole and fixed to an inner side of the annular member and another end connected to said weight.

4. The apparatus as claimed in claim 1, wherein said rotary member comprises a main plate facing said body and freely rotatably mounted to said post so as to rotate freely about the central axis of the center post parallel to said body, said plate having an indicator mark adjacent the circle along which the graduations of the body are spaced.

5. The apparatus as claimed in claim 4, wherein the plate of said rotary member has auxiliary graduations thereon alongside the graduations of the body, the auxiliary graduations being spaced from one another along an arc concentric with the circle along which the graduations of the body are spaced.

6. The apparatus as claimed in claim 5, wherein the auxiliary graduations are spaced from one another by intervals different from the intervals by which the graduations on the body are spaced from one another.

7. The apparatus as claimed in claim 5, wherein said indicator includes an auxiliary plate extending from and perpendicular to said plate having the indicator mark, a connecting string fixed to the rotary member and extending to an outer peripheral edge of the auxiliary plate, and a weight connected to an end of the connecting string adjacent the outer peripheral edge of the auxiliary plate, said auxiliary plate having graduations spaced along an arc at the outer peripheral edge thereof, the arc having a radius of curvature emanating from the central axis such that a said graduation of the auxiliary plate indicated by the connecting string and weight is indicative of the angle between the body and the connecting string.

8. An object alignment inspecting apparatus for use in ion implantation equipment, comprising:
a planar body;
a center post protruding from said body and having a central axis; and
an indicator including a rotary member comprising a main plate mounted to said post so as to be free to rotate about said central axis parallel to said body, an auxiliary plate extending from and perpendicular to said main plate, said auxiliary plate having graduations spaced along an arc lying in a plane perpendicular to said rotary member, and an indicating member mounted to the rotary member so as to swing freely relative thereto and extending to said arc along which the graduations are spaced, whereby a said graduation of the auxiliary plate indicated by the indicating member is indicative of the slope at which the body is inclined relative to the vertical.

9. The apparatus as claimed in claim 8, wherein said indicating member comprises a string, and a weight mounted to the end of the string.

10. A method of ensuring that an object will be oriented for ion implantation within a predetermined range in ion implantation equipment that includes a disc on which the object is situated during the ion implantation process, an alignment unit that aligns the object prior to the ion implantation process, and a transportation device that transfers the aligned object from the alignment unit to the disc, said method comprising:
providing an alignment angle inspecting apparatus having a series of graduations from which a relative rotational position of the apparatus can be read;
placing the alignment angle inspecting apparatus on the disc, and noting the relative rotational position of the apparatus on the disc as indicated by the graduations;
using the transportation device to transfer the object alignment angle inspecting apparatus from the disc to the alignment unit;
noting the relative rotational position of the apparatus in the alignment unit as indicated by the graduations of the apparatus; and
comparing the relative rotational positions of the object alignment angle inspecting apparatus on the disc and in the alignment unit to determine whether the object transported by the transportation unit from the alignment unit to the disc will assume a relative rotational position on the disc within a predetermined range.

11. The method as claimed in claim 10, and further comprising adjusting the position of the disc based on said comparing of the relative rotational positions of the object alignment angle inspecting apparatus.

12. The method as claimed in claim 10, and further comprising adjusting a driving mechanism of the alignment unit based on said comparing of the relative rotational positions of the object alignment angle inspecting apparatus.

13. The method as claimed in any one of claim 10, and further comprising using the transportation device to transfer the object angle alignment apparatus from the alignment unit to the disc, and thereupon noting the relative rotational position of the apparatus on the disc to check whether the transportation unit maintains the alignment of the object.
